(19) United States
(12) Patent Application Publication
(10) Pub. No.: US 2008/0201778 A1
(43) Pub. Date: Aug. 21, 2008

(54) INTRUSION DETECTION USING SYSTEM CALL MONITORS ON A BAYESIAN NETWORK

(75) Inventors: Jinhong Guo, West Windsor, NJ (US); Stephen L. Johnson, Erdenheim, PA (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/677,059

(22) Filed: Feb. 21, 2007

(51) Int. Cl. G06F 12/14

(52) U.S. Cl. 726/23

(57) ABSTRACT

Selected system calls are monitored to generate frequency data that is input to a probabilistic intrusion detection analyzer which generates a likelihood score indicative of whether the system calls being monitored were produced by a computer system whose security has been compromised. A first Bayesian network is trained on data from a compromised system and a second Bayesian network is trained on data from a normal system. The probabilistic intrusion detection analyzer considers likelihood data from both Bayesian networks to generate the intrusion detection measure.

### BACKGROUND AND SUMMARY

The present invention relates generally to computer security and computer intrusion detection. More particularly, the invention relates to an intrusion detection system and method employing probabilistic models to discriminate between normal and compromised computer behavior.

Computer security is a significant concern today. Because of the widespread use of the internet to view web pages, download files, receive and send e-mail and participate in peer-to-peer communication and sharing, every computer user is at risk. Computer viruses, worms and other malicious payloads can be delivered and installed on a user's computer, without his or her knowledge. In some cases, these malicious payloads are designed to corrupt or destroy data on the user's computer. In other instances, such malicious payloads may take over operation of the user's computer, causing it to perform operations that the user does not intend, and which the user may be unaware of. In one of its more pernicious forms, the user's computer is turned into a zombie computer that surreptitiously broadcasts the malicious payload to other computers on the internet. In this way, a computer virus or worm can spread very quickly and infect many computers in a matter of hours.

The common way of addressing this problem is to employ virus scanning software on each user's computer. The scanning software is provided, in advance, with a collection of virus “signatures” representing snippets of executable code that are unique to the particular virus or worm. The virus scanning software then alerts the user if it finds one of these signatures on the user's hard disk or in the user's computer memory. Some virus scanning programs will also automatically cordon off or delete the offending virus or worm, so that it does not have much of an opportunity to spread.

While conventional virus scanning software is partially effective, there is always some temporal gap from the time the virus or worm starts to spread and the time the virus signature of that malicious payload can be generated and distributed to users of the scanning software. In addition, many people operate their computers for weeks or months at a time without updating their virus signatures. Such users are more vulnerable to any new malicious payloads which are not reflected in the virus signatures used by their scanning software.

The present invention takes an entirely different approach to the computer security problem. Instead of attempting to detect signatures of suspected viruses or worms, our system monitors the behavior of the user's computer itself and watches for behavior that is statistically suspect. More specifically, our system monitors the actual system calls or messages which propagate between processes running within the computer's operating system and/or between the operating system and user application software running on that system. Our system includes a trained statistical model, such as a Bayesian network, that is used to discriminate abnormal or compromised behavior from normal behavior. Thus, if a virus or worm infects the user's computer, the malicious operations effected by the intruding software will cause the operating system and/or user applications to initiate patterns of system calls or inter-process messages that correspond to suspicious or compromised behavior.

In a presently preferred embodiment, plural trained models are included, such as one model trained to recognize normal system behavior and another model trained to recognize compromised system behavior. Monitors are placed on selected system calls and the frequency of those calls within a predetermined time frame are then fed to the trained models. The frequency pattern (or patterns in the case where multiple system calls are monitored) are used as inputs to the trained Bayesian networks and likelihood scores are generated. If the likelihood score of the “compromised” model is high, and the score of the normal model is low, then an intrusion detection is declared. The computer can be programmed to halt the offending behavior, or shut down entirely, as necessary, to prevent the malicious payload from spreading or causing further damage.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIGS. 1a-1c are software block diagrams illustrating how the probabilistic intrusion detection system of the invention may be implemented in a variety of different computer operating system architectures. Specifically, FIG. 1a illustrates an example where a monolithic kernel is employed. FIG. 1b illustrates how the probabilistic intrusion detection system may be deployed with a micro kernel operating system architecture. FIG. 1c illustrates deployment in a hybrid architecture.

FIG. 2 is a software block diagram illustrating a prior art security module framework which features a security module hook that may be used to interface with a security module policy engine.

FIG. 3 is a software block diagram illustrating how the probabilistic intrusion detection system may be connected to a security module system of the type shown in FIG. 2.

FIG. 4 shows in further detail how the output from a plurality of security module hooks can be captured and analyzed over a pre-determined timeframe or time window.

FIG. 5 illustrates how the data gathered in FIG. 4 may be collectively analyzed and applied as input to a Bayesian network system.

FIG. 6 shows the Bayesian network system in greater detail, specifically illustrating an example where a first network is trained to recognize normal operation and a second network is trained to recognize compromised operation.

FIG. 7 shows an example of Bayesian network graph.

FIG. 8 shows an example of a Bayesian network graph with probability association.

### DESCRIPTION OF THE PREFERRED EMBODIMENTS

The following description is merely exemplary in nature and is not intended to limit the present disclosure, application, or uses.

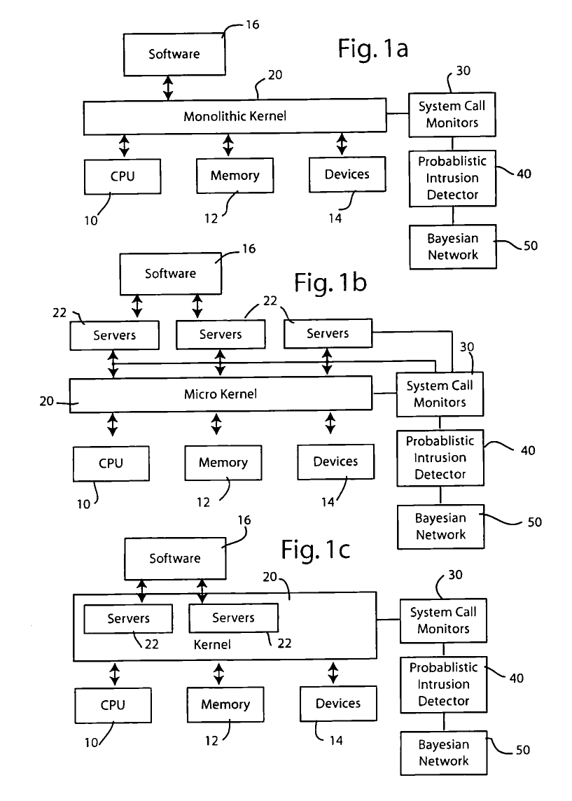

The present invention can be used with numerous different operating system architectures. For illustration purposes, three popular architectures have been illustrated in FIGS. 1a-1c. Computer operating systems are designed to communicate with the computer central processing unit or units, with the computer's memory and with an assortment of input/output devices. The fundamental or central operating system component charged with responsibility of communicating with the CPU, memory and devices is called the kernel. What functions are allocated to the kernel and what functions are allocated to other parts of the operating system are defined by the architecture of the operating system.

As illustrated in FIG. 1a, one type of operating system architecture employs a monolithic kernel 20 that interfaces between the CPU 10, memory 12 and devices 14 and the application software 16.

As illustrated in FIG. 1b, a different architecture is presented. In this architecture, a micro kernel 20 supplies the basic functionality needed to communicate with CPU 10, memory 12 and devices 14. However, a collection of servers 22 interface the micro kernel 20 with the software 16. Note that in this context, the term “servers” refers to those operating system components which provide higher level functionality needed to interface with the application software 16. Thus, the micro kernel 20 and servers 22 of the architecture illustrated in FIG. 1b generally perform the same functions as the monolithic kernel 20 of FIG. 1a.

FIG. 1c illustrates a hybrid architecture where the servers 22 are embedded into the kernel 20. Comparing the architecture of FIG. 1c with that of FIG. 1a, a fundamental difference lies in the manner in which the servers operate. With the architecture of FIG. 1c, if one of the servers were to crash, the rest of the kernel would remain operative, and the crashed server would simply need to be stopped and restarted. In the architecture of FIG. 1a, a crash in any component of the monolithic kernel would result in the entire machine crashing, forcing a reboot.

The present invention is designed to interface with the kernel and/or its associated servers, to monitor system calls. A system call is the mechanism by which a user-level application requests services from the underlying operating system. As will be understood upon reading the remainder of this description, the invention monitors selected system calls when the security of a computer system has been violated (as illustrated in each of FIGS. 1a-1c), the invention employs a set of system call monitors 30 which are suitably coupled to the operating system preferably to the operating system kernel so that selected system calls can be monitored. The system call monitors 30 gather data over a predetermined time, such as during a predetermined time window, to generate event frequency data.

The event frequency data is then analyzed by a probabilistic intrusion detector 40 that uses a Bayesian network system 50 to analyze the event frequency data.

By way of further illustration, note that the system call monitors 30 can be placed to monitor events mediated by the monolithic kernel (FIG. 1a), by the micro kernel and/or servers (FIG. 1b) and by the hybrid kernel and server combination (FIG. 1c).

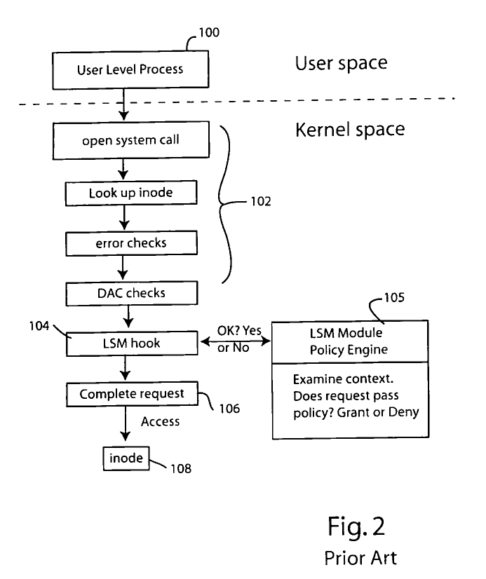

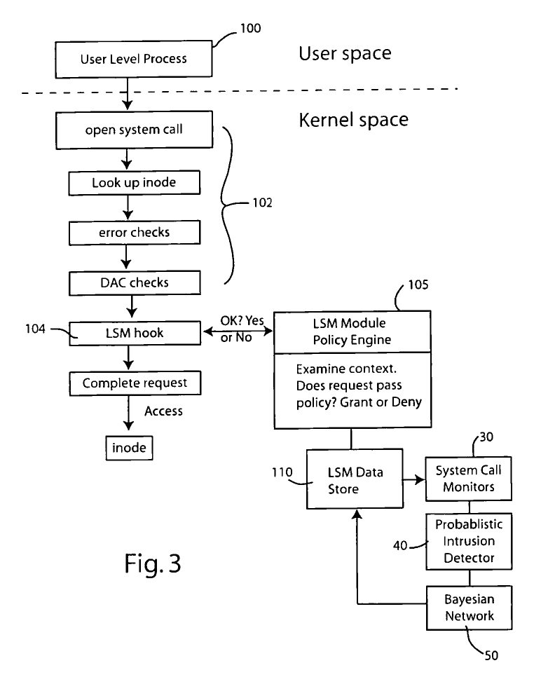

Depending on the configuration of the operating system, there are many ways to attach system call monitors to the operating system. FIGS. 2 and 3 illustrate how the system call monitors might be attached in a Unix operating system, such as the Linux. FIG. 2 illustrates some of the internal system call processes executed within the Linux operating system. More specifically, FIG. 2 illustrates how a security module policy engine may be attached to monitor system calls. FIG. 2 is based on the Linux security module framework (LSM).

Referring to FIG. 2, a user level process is first initiated at 100. As illustrated, this process may be initiated in the user space of the operating system. The user level process might be, for example, a process launched by a software application. The user level process then causes a series of events to occur in kernel space mediated by the kernel of the operating system. The user process executes a system call which traverses the kernel's existing logic for finding and allocating resources, performing error checking and passing the classical Unix discretionary access controls (DAC). This is illustrated in FIG. 2 by the steps shown generally at 102. According to the Linux security module framework, before the request is completed at 106, a Linux security module (LSM) hook is placed at 104. The hook makes an out call to the LSM module policy engine 105, which examines the context of the request for services to determine if that request passes or fails an applicable security policy. If the request passes, then the message is allowed to progress to the complete request step whereby access to a resource such as an inode 108 is granted. Conversely, if the security policy is violated, the request for access if intercepted at the LSM hook 104 and access to the requested resource is inhibited.

Referring to FIG. 3, we can now see how the system call monitors 30, probabilistic intrusion detector 40 with Bayesian network 50 may be deployed in the exemplary Linux operating system. As illustrated, the intrusion detection system of the invention can be attached using the same mechanism (LSM hook 104) that is used by the LSM module policy engine 105. In this regard, the LSM module policy engine 105 has an associated data store 110 that it uses to store information extracted from the LSM hook 104 and also store intermediate and final grant/deny results which control access to the requested target. The probabilistic intrusion detector 40 and system call monitors 30 of the present invention may be configured to share this data store 110. Specifically, the system call monitors 30 may be configured to monitor and gather data as system call requests are captured by the LSM hook and module policy engine. The probabilistic intrusion detector 40 processes the data gathered by the system call monitors 30 and, if desired, may store intermediate and/or final intrusion detection measures (intrusion detection results) in the LSM data store 110. Alternatively, a separate data store may be used to store these data.

Illustrated in FIG. 3 was an example based on the LSM framework. The LSM is a framework for security modules, implemented by placing hooks at the system call interface. The LSM framework comes with some default modules. However, it is not necessary to use them in order to implement the invention. As an example of one alternative, one can utilize the interface and implement the intrusion detection scheme as a security module or in combination as part of a mandatory access control security module. The scenario in FIG. 3 is the latter case in which the intrusion detection scheme rides on another module that grants or denies accesses. One can also implement this as an independent module using the hooks to intercept the system calls for monitoring and the security fields provided by LSM (110 in the FIG.) to store our data. In this case, one can either always grant access as part of the yes/no for LSM hooks or one can use the final detection result by the Bayesian network to grant or deny the access.

It should be understood that the foregoing description of how to place system call monitors in communication with the operating system represents one example that is particularly suited to exploit the Linux security module framework available for the Linux operating system. It should be appreciated that there are numerous other ways of attaching the system call monitors to the operating system. Essentially, any technique that allows the system calls to be monitored, preferably in real time, may be used.

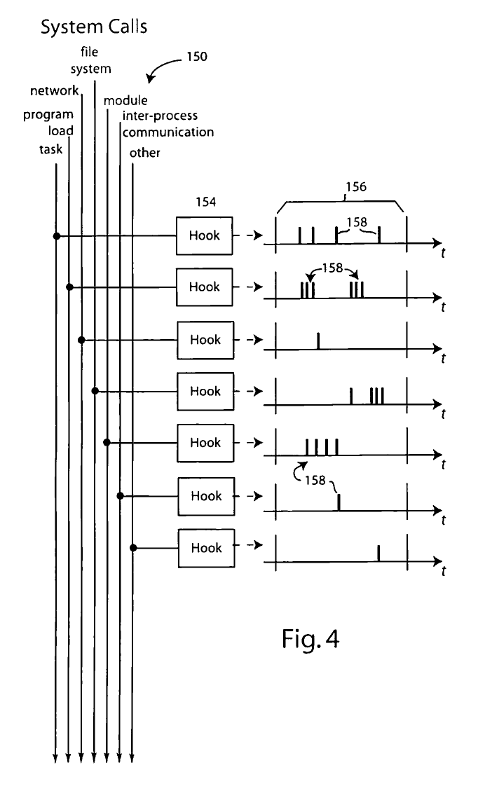

Referring now to FIG. 4, some of the techniques implemented by the present invention will be described in greater detail. In a presently preferred embodiment one system call, or plural system calls, can be monitored. The choice of which system calls to monitor will be made based on the types of behavior that may be expected when a virus or worm infects a computer system.

For illustration purposes. FIG. 4 depicts a collection of system calls generally at 150. It should be understood that FIG. 4 is intended to show examples of system calls, taken from a much larger possible set. In an actual implementation, perhaps only a portion of the set of system calls would be monitored. Thus, FIG. 4 is intended to show the general case where any of the available system calls may potentially be monitored. For each type of system call monitored, there is a hook 154 (analogous to the LSM hook 104 of FIGS. 2 and 3) which collects event data from that system call. The events are collected and analyzed over a given time frame or during a given time window. In FIG. 4, the time window illustrated diagrammatically at 156 and the individual events are depicted as vertical bars 158. As illustrated, the events occur in a temporal sequence and this may be captured datalogically by recording the time stamp at which the event occurred.

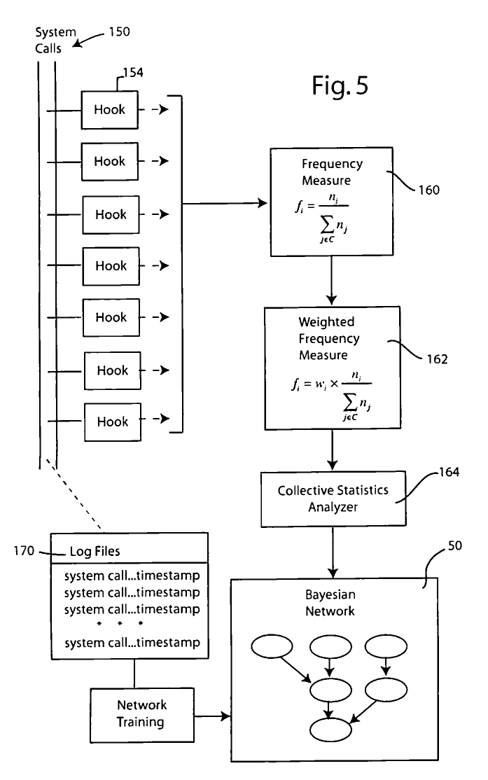

The individual events 158 are analyzed over the time window 156 to generate frequency data for each type of system call. Then, as illustrated in FIG. 5, the individual frequency data are combined to generate a frequency measure shown in the computation block 160. If desired, the frequency measure can be modified by applying a weight for each frequency. The appropriate weights are developed during training. Without training, the default values for the weights can be set to 1. The weighted frequency measure is thus illustrated in computation block 162.

The frequency measure data (or weighted frequency measure data) is then supplied to a collective statistics analyzer module 164 which uses a set of Bayesian networks 50. As will be more fully explained below, the Bayesian networks are trained on examples of normal system operation and compromised system operation. If desired, the data used to train the Bayesian networks can be extracted from log files, such as log files 170, which record tuples comprising a system call and the time stamp at which the system call occurred.

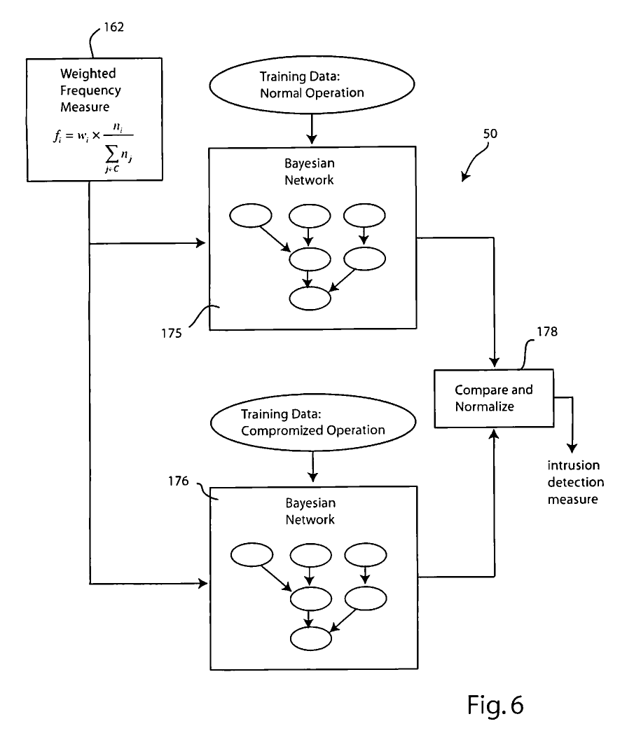

Referring now to FIG. 6, the Bayesian network 50 is shown in greater detail. As discussed above a preferred embodiment may use multiple Bayesian networks, such as one network that is trained by observing system calls during normal operation. This network is illustrated diagrammatically at 175. Another Bayesian network 176 is trained on data extracted from a system that has been compromised. The collective statistics analyzer 164 (FIG. 5) submits that weighted frequency data 162 to both Bayesian networks 175 and 176. Each of the networks outputs a probability score (indicating the likelihood that the hypothesis it is designed to recognize is true). Thus. Bayesian network 175 outputs a probability that the weighted frequency measure data was generated by a computer operating normally; and Bayesian network 176 outputs a probability score that the computer has been compromised. The respective probability scores are compared and normalized at 178 to produce the output intrusion detection measure. This intrusion detection measure can then be used in a variety of ways, including alerting the user that his or her system has been compromised, suspending or terminating the behavior that produced the high compromised operation score, terminating or suspending any incoming and/or outgoing communications, or by terminating or suspending computer operation altogether.

### System Design Considerations

In the general case, the Bayesian networks of the probabilistic intrusion detection system can be trained to recognize any kind of abnormal behavior, so that appropriate action can be taken. In many practical applications the objective may be more focused, mainly to detect and react appropriately when malicious payloads are introduced. Regardless of the function of each malicious payload, we can consider certain patterns of behavior as abnormal. For example, a typical worm scans for ports. It may also send out numerous e-mails in a short duration of time. Thus, system calls used to perform port scans and used to send out e-mails would be the appropriate system calls to monitor. Although it is possible build a system which monitors only a single type of system call, more robust results are obtained by monitoring a set of different system calls selected because those calls would be implicated in the types of behaviors exhibited when malicious payloads are delivered. For example, a malicious payload typically will not frantically open a large number of sockets; it will also access a number of files. Thus, monitoring socket opening and file access together will produce more robust detection.

In designing an intrusion detection system, it can be helpful to initially set up monitors on all available system calls, such as depicted in FIG. 4. The system is then observed during normal operation and data is gathered from each of the hooks. Once a consistent body of data has been collected for the normal operation training, different types of viruses, worms and other malicious payloads are installed on the computer and further system call data are collected. Because a given malicious payload may corrupt the operating system, thereby altering its future behavior, it may be preferable to sterilize the environment after each malicious test, reinstall the system for normal operation and then introduce a subsequent malicious payload. The objective is to gather sufficient data for different types of malicious payloads, so that these may be used to train the Bayesian network to recognize compromised computer behavior.

As previously discussed, and illustrated in FIG. 5, a presently preferred embodiment can use frequency data defined in equation 1:

$${f}_{i} = {\sum }_{\int ∈ C}^{\underline{{n}_{i}}} {n}_{j}$$

Where nᵢ is the number of system calls that happened during the specified time duration and C is the complete set of system calls. Each of these frequencies can be used to monitor an isolated system call.

The frequency value can be an indication or measure of risk that a specific system call is being misused or compromised. To take into account the fact that some system calls have higher risk than others, the embodiment illustrated in FIG. 5 defines the risk factor, i.e., the probability that the system call is being compromised as a weighted value as set forth in Equation 2:

$${f}_{i} = {w}_{i} \times {\sum }_{\int ∈ C}^{\underline{{n}_{i}}} {n}_{j}$$

Where wᵢ is a weight for each fᵢ. These weights can be determined through training. Without training, the default value for these weights can be set at:

wᵢ=1

As noted above, the more robust detection system relies on collective statistics derived from a plurality of monitors placed at the system call interface. The Bayesian network thus serves as a good technique for assimilating the information contained within these collective statistics. One advantage of the Bayesian network is that it captures relationships among variables and more specifically, the dependencies among variables. Graphically, a Bayesian network may be shown as a directed acyclic graph in which the variables can be represented as nodes, and the dependencies among the variables are represented as directional arrows or arcs.

In a presently preferred embodiment, the arcs are also associated with local probability distributions, given the value of its parents. Thus, the Bayesian network consists of a set of local probability distributions with a set of conditional independendent probability distributions.

The assumption of Bayesian network theory is that

p(x₁|x₁, x₂, . . . , xᵢ₋₁. ξ)=p(x|Πᵢ, ξ)

Where

Πᵢ∈{x₁, x₂, . . . , x_{i-1}}

This implies that the Bayesian network assumes a conditional independence among its variables unless they are directly linked by an arc.

The chain rule of probability states that for each variable Xᵢ, i=1 ,2, . . . n, the joint distribution

$$P ( {X}_{1} , {X}_{2} , … , {X}_{n} ) = {\prod }_{i = 1}^{n} P ( {X}_{i} \text{\textbar} parents ( {X}_{i} ) )$$

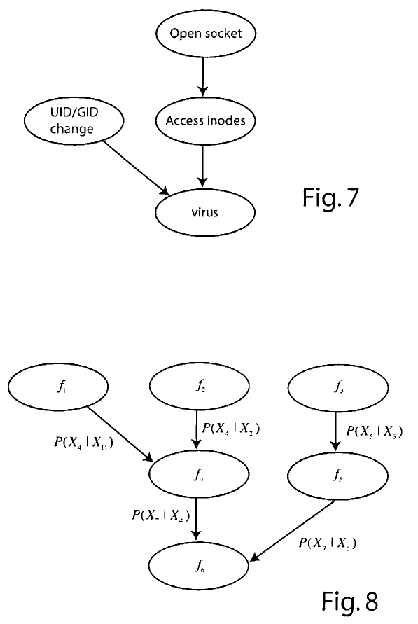

An example of a graph is show in FIG. 7. In this figure, we have two branches that both indicate a possible virus attack. One of the branches involves opening socket, and then accesses certain inodes while trying to propagate. The other branch involves UID/GID changes. The probabilities associated with each transaction can be pre-trained. Intuitively, the probability represented by the arc from UID/GID change to the final indication of virus is greater as this is a more suspicious behavior as the process trying to change its identity, either for disguising or for priority escalation.

A simplified example of the Bayesian network that incorporates fᵢ band the probabilities is shown in FIG. 8.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An intrusion detection apparatus for use in a computer system having an operating system that employs system calls to effect control over computer system resources, comprising:
a monitor system adapted to monitor predetermined system calls;
a data collection system coupled to said monitor system and operative to collect data reflective of system calls monitored by said monitor system:
a probabilistic intrusion detection analyzer coupled to said data collection system;
said probabilistic intrusion detection analyzer employing at least one trained model adapted to yield at least one likelihood score indicative of whether the system calls monitored by said monitor system were produced by a computer system whose security has been compromised.

2. The intrusion detection apparatus of claim 1 wherein said monitor system employs at least one software hook introduced into the path of an operating system call that carries said system call within the operating system.

3. The intrusion detection apparatus of claim 1 wherein said monitor system is adapted to monitor a plurality of different types of system calls.

4. The intrusion detection apparatus of claim 3 wherein said different types of system calls correspond to system calls associated with behavior of a computer system whose security has been compromised.

5. The intrusion detection apparatus of claim 1 wherein said data collection system collects data reflective of the occurrence frequency of system calls during a predetermined time window.

6. The intrusion detection apparatus of claim 5 wherein said data collection system collects occurrence frequency data for a plurality of different types of system calls.

7. The intrusion detection apparatus of claim 6 wherein said data collection system applies weights to said occurrence frequency data to emphasize occurrence frequency data associated with selected ones of said different types of system calls.

8. The intrusion detection apparatus of claim 1 wherein said probabilistic intrusion detection analyzer employs:
a first model trained on a first dataset developed from a computer system whose security has been compromised; and
a second model trained on a second dataset developed from a computer system whose security has not been compromised.

9. The intrusion detection apparatus of claim 1 wherein said trained model includes a Bayesian network.

10. The intrusion detection apparatus of claim 8 wherein said first and second datasets are developed from log files generated by the operating system.

11. A method of automatically detecting when the security of a computer system has been compromised, comprising the steps of:
monitoring predetermined system calls employed by the operating system of the computer;
collecting and storing data from said monitoring step;
processing said collected data using at least one trained model and using said model to generate at least one likelihood score indicative of whether the system calls being monitored were produced by a computer system whose security has been compromised;
using said likelihood score to produce an intrusion detection measure.

12. The method of claim 11 wherein said monitoring step is performed by placing at least one software hook into the path of an operating system call that carries said system call within the operating system and monitoring inter-process communications arriving at said software hook.

13. The method of claim 11 wherein said monitoring step is performed by monitoring a plurality of different types of system calls.

14. The method of claim 11 wherein said monitoring step is performed by monitoring a plurality of different types of system calls corresponding to system calls associated with behavior of a computer system whose security has been compromised.

15. The method of claim 11 wherein said collecting step includes collecting data reflective of the occurrence frequency of system calls during a predetermined time window.

16. The method of claim 15 wherein said collecting step further comprises collecting frequency data for a plurality of different types of system calls.

17. The method of claim 15 wherein said collecting step further comprises applying weights to said frequency data to emphasize occurrence frequency data associated with selected ones of said different types of system calls.

18. The method of claim 11 wherein said processing step uses a first model trained on a first dataset developed from a computer system whose security has been compromised; and
a second model trained on a second dataset developed from a computer system whose security has not been compromised.

19. The method of claim 11 wherein said trained model includes a Bayesian network.

20. The method of claim 18 further comprising training said first and second datasets using log files generated by the operating system.
